(19) United States
(12) Patent Application Publication
(10) Pub. No.: US 2026/0179136 A1
(43) Pub. Date: Jun. 25, 2026

(54) ITEM RECOMMENDATION AND VISUALIZATION

(71) Applicant: eBay Inc., San Jose, CA (US)

(72) Inventors: Yotam Eshel, Ein Iron (IL); TAL AHARON FRANJI-GEFEN, HaSharon (IL); Yonatan Israel Hadar, Raanana (IL); Oded Zinman, Tel Aviv – Yafo (IL)

(73) Assignee: eBay Inc., San Jose, CA (US)

(21) Appl. No.: 19/000,067

(22) Filed: Dec. 23, 2024

(51) Int. Cl. G06Q 30/0601; G06F 40/279; G06F 40/40; G06T 3/40; G06T 11/00; G06V 20/20; G06V 20/50; G06V 20/70

(52) U.S. Cl. CPC G06Q 30/0631; G06F 40/279; G06F 40/40; G06Q 30/0603; G06T 3/40; G06T 11/00; G06V 20/20; G06V 20/50; G06V 20/70; G06T 2200/24

(57) ABSTRACT

In implementations of systems and procedures for item recommendation and visualization, a computing device receives an input digital image depicting an environment and identifies attributes of objects within the environment. The attributes of the objects are used to identify items from item catalog data that have similar attributes and are suitable for inclusion within the environment. The identified items are displayed by way of a recommendation. The attributes of the objects are further used for generation of synthesized images. The synthesized images depict objects from the input digital image virtually replaced by items from the item catalog data. The synthesized images thus support visualization of the items within the environment depicted by the input digital image.

### BACKGROUND

Service provider systems are configurable to employ digital services that are accessible via a network in support of operations involving items. Such service provider systems often provide interfaces that support browsing of cataloged items. In some cases, the cataloged items can include a wide variety of different item types. While browsing items, digital images depicting the items can be viewed by users. The digital images often originate from various different sources such as manufacturers of the items, individuals associated with operation of the service provider system, other users, and so forth.

The wide variety of different item types and the different sources of digital images can lead to large differences in the depictions of the items in the digital images. Items that are of a same type or category can also be depicted using different perspectives, different lighting, different environments, and so forth. Technical challenges introduced by the differences in depictions of the items by the service provider systems can cause items that would appear similar under controlled conditions to appear different. Consequently, these technical challenges introduce difficulties in a user's ability to compare items and visualize how the items might appear in different environments using a computing device when interacting with conventional service provider systems.

### SUMMARY

Item recommendation and visualization techniques are described. In one or more implementations, an input digital image is received that depicts an environment. Attributes of an object within the environment are identified, and the attributes are used to identify one or more items from item catalog data that have similar attributes and are suitable for inclusion within the environment. The identified items are displayable by way of a recommendation. The attributes of the object are further used for generation of synthesized images. The synthesized images depict the object from the input digital image as virtually replaced by the one or more items from the item catalog data. The synthesized images thus support visualization of the one or more items within the environment as depicted by the input digital image.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of an environment in an example implementation that is operable to employ item recommendation and visualization as described herein.

FIG. 2 depicts an example implementation showing modules and other components employed for item recommendation and visualization as described herein.

FIG. 3 depicts an example implementation showing example operations performed for item recommendation and visualization as described herein.

FIG. 4 depicts an example implementation showing other example operations performed for item recommendation and visualization system as described herein.

FIG. 5 depicts an example implementation showing a graphical user interface implemented for item recommendation and visualization as described herein.

FIG. 6 depicts an example implementation showing an image selection menu of the graphical user interface.

FIG. 7 depicts an example implementation showing a synthesized image displayed by the graphical user interface.

FIG. 8 depicts an example implementation showing a side-by-side comparison of the synthesized image and an input digital image as displayed by the graphical user interface.

FIG. 9 depicts an example implementation showing recommendations for items generated based on the input digital image and displayed by the graphical user interface.

FIG. 10 shows a flow diagram depicting a procedure in an example implementation which includes generation of item visualizations.

FIG. 11 shows a flow diagram depicting a procedure in an example implementation which includes generation of item recommendations.

FIG. 12 illustrates an example system that includes an example computing device that is representative of one or more computing systems and/or devices for implementing the various techniques described herein.

### DETAILED DESCRIPTION

### Overview

A service provider system can present information describing various items. For example, a service provider system can maintain item catalog data describing different types of items such as furniture, electronics, toys, and so forth. User devices can access a platform implemented by the service provider system over a network in order to browse the items described by the item catalog data. In some cases, each item is associated with a respective webpage maintained by the service provider system. User devices can view information associated with the item by communicating electronically with the service provider system to navigate to the corresponding webpage via a web browser or other application.

Some items can be depicted on the platform using one or more images accessible to the service provider system. For example, images associated with the items can be retrieved from databases or other storage employed by the service provider system. In some cases, the item images are included in the item catalog data. Although the item images depict the appearance of the items, the environments in which the items are depicted can vary greatly.

Consider a scenario in which the item catalog data includes information describing a first item and a second item. In this scenario, the item catalog data includes various digital photographic images of the first item and the second item. However, the first item may have been photographed at a different location than the second item. The environment depicted in the images of the first item thus differs from the environment depicted in the images of the second item. As an example, the images of the first item may have been acquired at a location of manufacture of the first item, while the images of the second item may have been acquired at a location of manufacture of the second item.

The differences between the environments depicted by digital images, such as the differences described above, can cause differences in appearances of items in the images. The resulting differences in item appearance can cause items that are physically similar to appear substantially different. Technical challenges introduced by such differences can include misidentification or mislabeling of similar items and/or other issues. For example, a service provider system can be operable to select representative images associated with items using images available to the service provider system. However, differences in item appearance in the images can cause unpredictable behavior during selection of representative images. The unpredictable behavior can lead to selection of representative images that include blurring, low pixel resolution, undesired color casts, and/or other undesirable image qualities. Different color casts, for example, can lead to mislabeling of items in situations in which labels for the items are automatically generated based on average pixel color values of the images.

In some situations, the service provider system is operable to generate a webpage or other browsable content associated with an item based on images provided to the service provider system. However, differences in appearance of the item from image to image can cause the service provider system to generate multiple webpages for the same item. This can increase a computational burden on the service provider system, consume additional memory and/or storage resources, and lead to duplicate entries in searches performed using the service provider system.

The technical challenges associated with the differences in depictions of items can also introduce difficulties for users comparing the items. For example, a space in which a first item is photographed may be much larger than a space in which a second item is photographed. As another example, images of a first item may be acquired from different perspectives relative to the images of a second item. Such differences can cause misconceptions for users as to the actual size and/or shape of the items. Such misconceptions can lead users to believe that they have identified items from the catalog that are suitable for a particular space. However, upon acquiring the items, users may find that the items do not fit within the space as expected and/or do not have a particular appearance as expected. This can result in user frustration.

Accordingly, item recommendation and visualization techniques are described that address these technical challenges. In one or more implementations, an item recommendation and visualization service is provided with digital images depicting an item. The service is additionally provided an input digital image depicting objects within an environment. The service processes the images and determines attributes associated with the item and attributes associated with the objects in the input digital image. An object in the input digital image is identified for replacement by the item. A synthesized image is generated that depicts the environment with the object replaced by the item depicted in the digital images. The attributes of the objects depicted by the input digital image are used to generate search keywords. The search keywords are employed to identify other items described in item catalog data that have attributes similar to attributes of the objects in the input digital image. The identified items are provided in a recommendation.

In this way, the item recommendation and visualization service generates synthesized images that depict items in selected environments. A synthesized image of an item generated in accordance with the described techniques can reduce or eliminate distortions of item appearance that are present in other images of the item. For example, the synthesized image can be generated without color casts, blurring, perspective distortions, and/or other image abnormalities that may be present in other images. Additionally, the item recommendation and visualization service is operable to generate the synthesized image depicting multiple different items in the selected environment. The item recommendation and visualization service thus supports relative comparison of the items using the synthesized image without introducing distortions associated with different environments. Respective synthesized images can be generated for multiple items to show the items in the selected environment individually. The item recommendation and visualization service thus supports respective depiction of each item within the same selected environment, and consistency of the appearance of the items can be increased.

As described above, the item recommendation and visualization service is further operable to identify items that have attributes similar to those of the objects in the input digital image. In doing so, the item recommendation and visualization service supports item catalog data searches that have increased accuracy relative to conventional approaches. In particular, the techniques described herein can be employed to determine attributes of objects in the input digital image without human input. In some instances, the item recommendation and visualization service employs at least one machine-learning model trained on historical search data of the service provider system to further increase the accuracy of the item catalog searches.

In addition to increasing the consistency of the appearance of the items, the techniques described herein enable user devices to display items within spaces selected by users. For example, the input digital image may be selected to depict an environment familiar to a user, such as an interior room associated with the user. Thus, items that have a suitable size, shape, and/or style can be easily identified, and the synthesized images can be generated without manual editing. In some instances, input digital images provided to the item recommendation and visualization system can be used to train learning models employed by the system to increase accuracy of the depiction of items in synthesized images.

In the following discussion, an exemplary environment is first described that may employ the techniques described herein. Examples of implementation details and procedures are then described which may be performed in the exemplary environment as well as other environments. Performance of the exemplary procedures is not limited to the exemplary environment and the exemplary environment is not limited to performance of the exemplary procedures.

### Example of an Environment

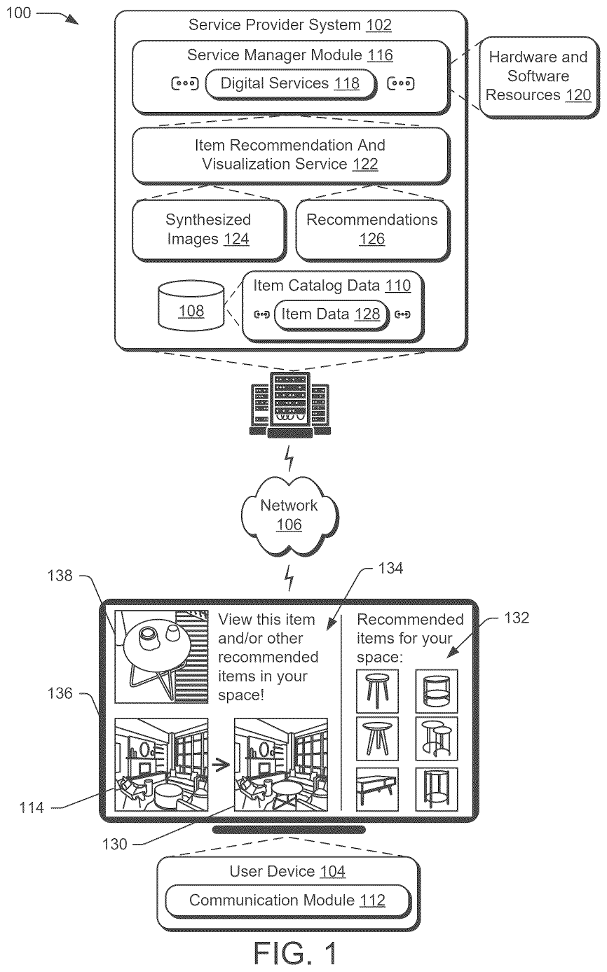

FIG. 1 is an illustration of a digital medium environment 100 in an example implementation that is operable to employ the item recommendation and visualization techniques described herein. The illustrated environment 100 includes a service provider system 102 and a user device 104 that are communicatively coupled, one to another, via a network 106. Computing devices that implement the service provider system 102 and the user device 104 are configurable in a variety of ways.

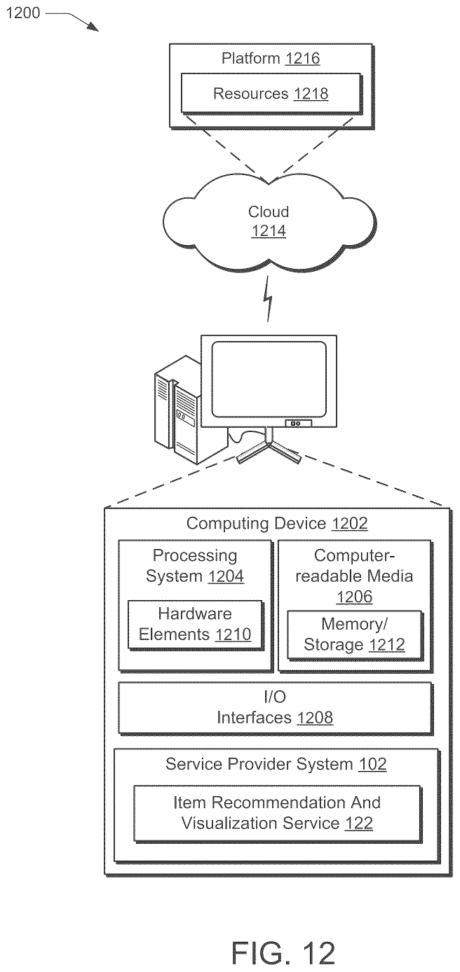

A computing device, for instance, is configurable as a desktop computer, a laptop computer, a mobile device (e.g., assuming a handheld configuration such as a tablet or mobile phone as illustrated), and so forth. Thus, a computing device ranges from full resource devices with substantial memory and processor resources (e.g., personal computers, game consoles) to a low-resource device with limited memory and/or processing resources (e.g., mobile devices). Additionally, although a single computing device is shown, a computing device is also representative of a plurality of different devices, such as multiple servers utilized by a business to perform operations “over the cloud” as described in FIG. 12.

The service provider system 102 supports the modules and systems described herein to implement a platform accessible to end users via other electronic devices such as personal computers, smartphones, and so forth. For instance, the service provider system 102 is configurable to include electronic storage media, transitory memory and non-transitory memory, one or more electronic processors, and other components configured to facilitate operation of the platform. The platform is accessible to users over the network 106. In some instances, the network 106 can be the internet, and the service provider system 102 implements the platform as a website.

In the depicted implementation, the service provider system 102 includes a storage device 108 employed for storage of data using memory or other storage media. The data can include, for example, item descriptions, item images, and other data associated with operation of the service provider system 102 and/or content provided by the service provider system 102 to end users. The storage device 108 is depicted including item catalog data 110. The item catalog data 110 describes a plurality of items that can be browsed by users of the platform of the service provider system 102. Each item described by the item catalog data 110 is associated with respective item data that can be viewed by users over the network 106. For example, the user device 104 can communicate electronically with the service provider system 102 over the network 106 via a communication module 112. The user device 104 can display content communicated over the service provider system 102 by the service provider system 102 to the user device 104 such as images and/or other information associated with the items described by the item catalog data 110. The user device 104 can be a smartphone, personal computer, tablet, or other type of computing device employing a display device (e.g., a display screen) to display of the item data. The user device 104 can further include memory or other storage configured to store digital images such as an input digital image 114.

The user device 104 includes a communication module 51 that is representative of functionality to communicate via the network 106 with a service manager module 116 of the service provider system 102, e.g., as a browser, a network-enabled application, and so on. The service manager module 116 is configured to implement digital services 118 using hardware and software resources 120, e.g., a processing device and a computer-readable storage medium. Digital services 118 are usable to expose a variety of functionality to the user device 104 via the network through execution by computing devices at the service provider system 102. Examples of digital services include social media services, digital content creation services, streaming services, digital content storage services, and so forth.

An item recommendation and visualization service 122, for instance, is an example of the digital services 118 that supports functionality involving the generation of synthesized images 124 and recommendations 126 for items from the item catalog data 110. The item recommendation and visualization service 122 is operable to generate synthesized images 124 using data from a first source and a second source. In implementations, the first source includes data from the item catalog data 110 such as item data 128, and the second source includes one or more input digital images from a user device such as the user device 104. In some instances, the synthesized images 124 and/or the recommendations 126 may be stored in the storage device 108.

The user device 104 is depicted displaying a synthesized image 130 and a recommendation 132 in a user interface 134 displayed via a display device 136. The synthesized image 130 is an example of the synthesized images 124, and the recommendation 132 is an example of the recommendations 126. In this instance, the synthesized image 130 is generated by the item recommendation and visualization service 122 based on the input digital image 114 and an item image 138. The input digital image 114 is received by the item recommendation and visualization service 122 via electronic communication between the user device 104 and the service provider system 102. The item recommendation and visualization service 122 further receives the item image 138 from the item data 128. The item recommendation and visualization service 122 accordingly generates the synthesized image 130 showing an item depicted by the item image 138 in an environment depicted by the input digital image 114. The item recommendation and visualization service 122 further generates the recommendation 132 based on features depicted in the input digital image 114. Items included in the recommendation 132 have similar attributes to features depicted in the input digital image 114. Accordingly, the item recommendation and visualization service 122 expands visualization and recommendation functionalities of the service provider system 102 over conventional techniques. Such functionalities are further discussed in the following sections.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Item Recommendation and Visualization

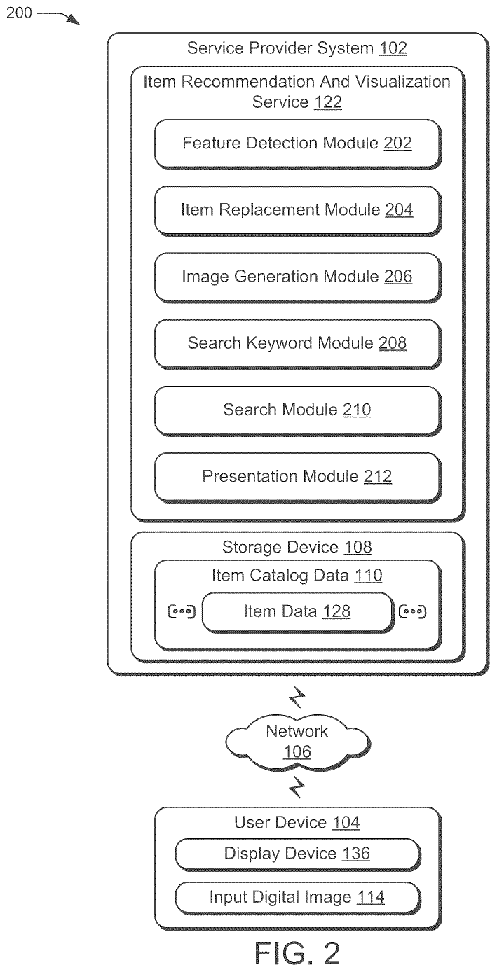

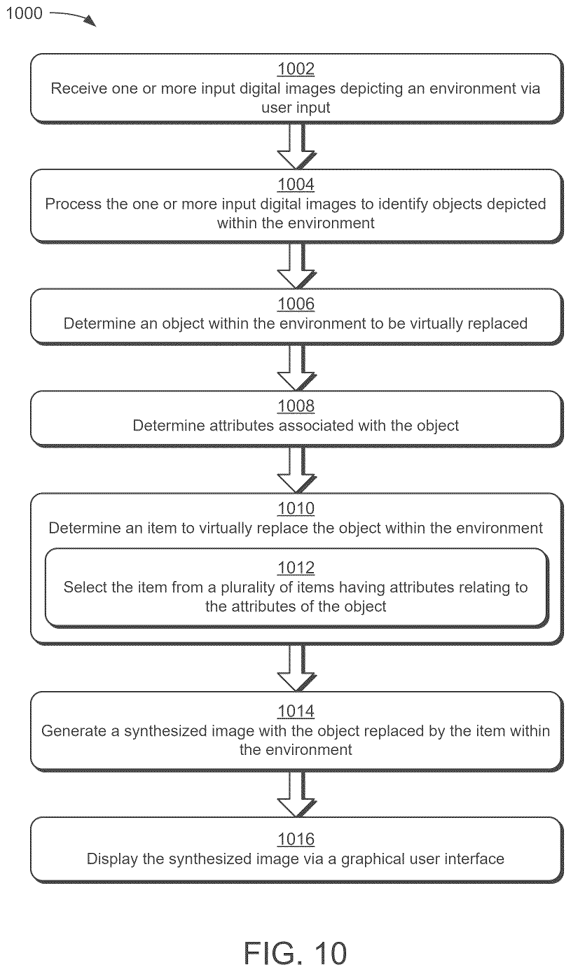

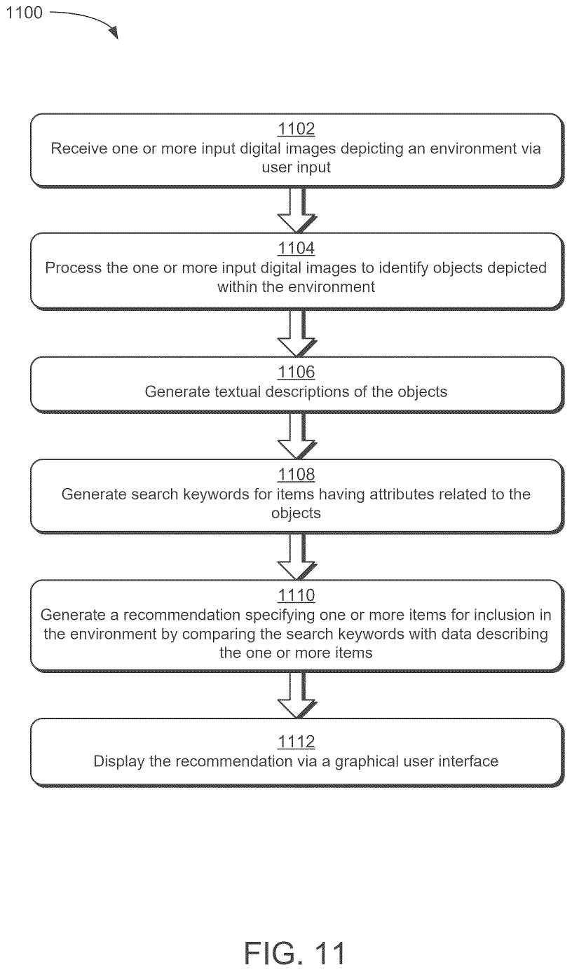

The following discussion describes item recommendation and visualization techniques that are implementable utilizing the described systems and devices. Aspects of the procedure are implemented in hardware, firmware, software, or a combination thereof. The procedures are shown as sets of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm. FIGS. 10 and 11 show flow diagrams depicting algorithms as step-by-step procedures 1000 and 1100, respectively, in example implementations of operations performable for accomplishing a result of item recommendation and visualization. In portions of the following discussion, reference will be made to FIGS. 2-9 in parallel with the procedure 1000 of FIG. 10 and the procedure 1000 of FIG. 11.

FIG. 2 depicts an example 200 of the item recommendation and visualization service 122 of FIG. 1 in greater detail. The item recommendation and visualization service 122 is depicted including a feature detection module 202, an item replacement module 204, an image generation module 206, a search keyword module 208, a search module 210, and a presentation module 212. The modules are employed to perform the item recommendation and visualization techniques described herein. The feature detection module 202 is employed to identify attributes of elements depicted in images provided to the item recommendation and visualization service 122. For example, the feature detection module 202 is operable to identify attributes of objects depicted in input digital images and attributes of items depicted by images in the item catalog data 110, such as images included by the item data 128. The attributes of the items may be referred to herein as item attributes. The item replacement module 204 is employed to determine objects in input digital images that can be replaced with depictions of items described by the item catalog data 110. The objects are determined based on the attributes identified by the feature detection module 202. The image generation module 206 is employed to generate the synthesized images 124 from the item catalog data 110 and the input digital images. The synthesized images are employed to support visualization of items described by the item catalog data 110 in environments depicted by the input digital images, such as the input digital image 114.

The feature detection module 202 is further operable to generate written descriptions of input digital images. The written descriptions are processed by the search keyword module 208 to generate keywords to be used for searching the item catalog data 110. The search module 210 searches the item catalog data 110 for items that have attributes similar to those described by the keywords. The presentation module 212 is operable to display the results of the search as the recommendations 126. The recommendations 126 (which may also be referred to herein as item recommendations) can be displayed, for example, at the display device 136 of the user device 104. The presentation module 212 is further operable to display the synthesized images 124 and other data associated with the described techniques.

The various modules, systems, and other components of the service provider system 102 are in electronic communication with each other. In some instances, the components communicate electronically with each other to exchange data via wired or wireless connections between the components. As an example of electronic communication, the storage device 108 is operable to electronically communicate with other components of the service provider system 102, such as modules employed by the item recommendation and visualization service 122 implemented by the service provider system 102.

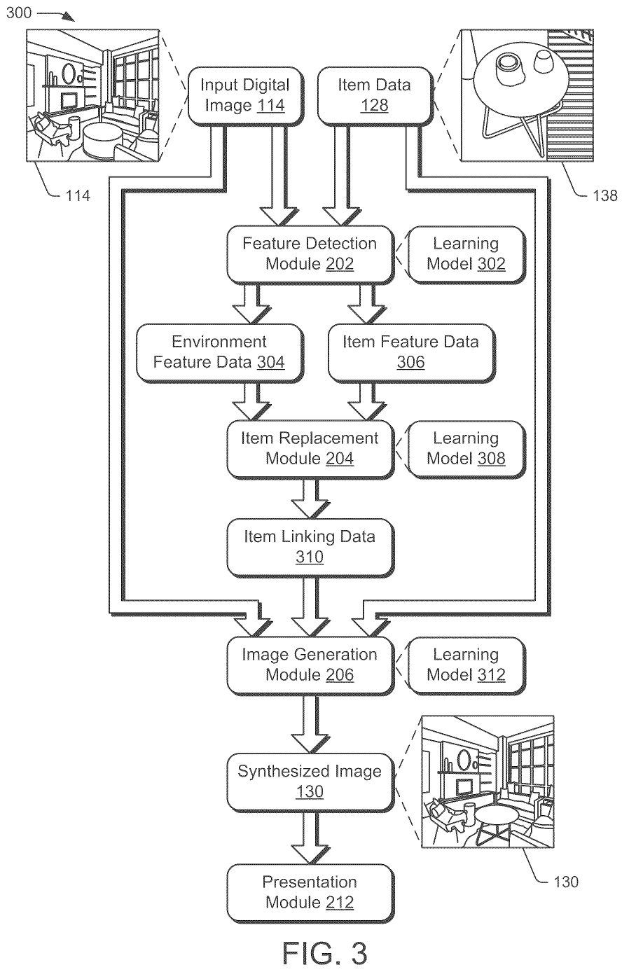

FIG. 3 depicts an example 300 of implementation of the item recommendation and visualization service 122 of FIGS. 1-2. In particular, FIG. 3 shows various modules of the item recommendation and visualization service 122 used to perform the item recommendation and visualization techniques described herein.

To begin in this example, one or more input digital images depicting an environment are received via user input (block 1002 and block 1102). In the depicted example, the input digital image 114 is received by the feature detection module 202. In some instances, the input digital image 114 can be provided to the service provider system 102 by way of uploading the input digital image 114 from the user device 104 over the network 106. In some instances, the input digital image 114 can be retrieved by the service provider system 102 from another location responsive to user input. For example, the input digital image 114 can be retrieved from cloud storage, from a web page specified by the user, or from another location accessible to the service provider system 102 via the network 106.

The input digital image 114 depicts the environment to be used by the item recommendation and visualization service 122 for the techniques described herein. The environment depicted by the input digital image 114 can be, for example, an interior of a building such as a bedroom, a kitchen, a living room, and so forth. The environment is not limited to interior spaces and can be an outdoor space such as an outdoor patio, a park, a yard, and so forth.

The feature detection module 202 additionally receives item data 128. The item data 128 is received from the item catalog data 110 stored in the storage device 108. The item data 128 includes one or more digital images of an item. The item data 128 can additionally include information such as a name of the item, a condition of the item, and so forth. The item may be a physical item such as a furniture item, electronic item, or other type of item as described above. The item catalog data 110 can describe many different items, and each item is associated with a respective instance of item data stored in the item catalog data 110. In some instances, the item catalog data 110 can include respective item data for more than a hundred items, more than a thousand items, and so forth.

Selection of the item data 128 to be received by the feature detection module 202 can be performed in various ways. In an example in which the user device 104 communicates electronically with the service provider system 102 for browsing of the items described in the item catalog data 110, the item data 128 may be associated with an item currently browsed by the user device 104. Browsing the item can include, for example, displaying a web page associated with the item at the user device 104, where the web page is employed by the service provider system 102 to display the images and/or other content included by the item data 128.

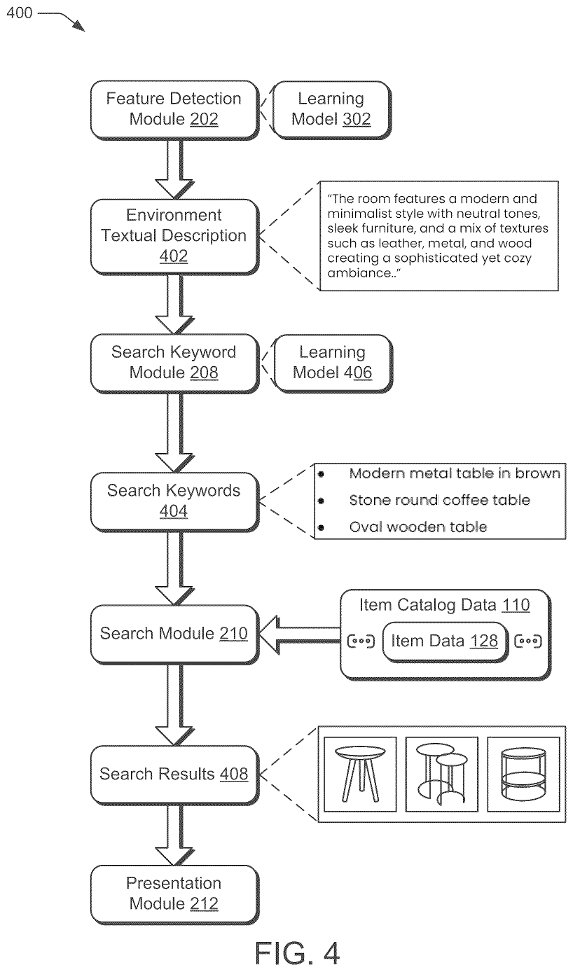

In another example, the item recommendation and visualization service 122 selects the item data 128 based on a content of the input digital image 114, as in the example described below with reference to FIG. 4. For instance, once the input digital image 114 is provided to the service provider system 102, the feature detection module 202 can be employed to identify the attributes of features within the input digital image 114. Based on the identified features, the item recommendation and visualization service 122 determines items described in the item catalog data 110 that have attributes similar to the identified attributes from the input digital image 114. The operations described herein can thus be performed for multiple instances of item data to generate multiple synthesized images. Each synthesized image can depict a respective item described by a corresponding instance of item data in the environment of the input digital image 114.

The feature detection module 202 receives the input digital image 114 and the item data 128 as described above and processes the input digital image 114 and the item data 128. To do so, the feature detection module 202 employs a learning model 302. The learning model 302 includes one or more machine-learning models and is operable to identify objects depicted within the input digital image 114. In particular, the feature detection module 202 employs the learning model 302 to process the input digital image 114 to identify objects depicted within the environment of the input digital image 114 (block 1004 and block 1104).

As used herein, the term “machine-learning model” refers to a computer representation that is tunable (e.g., through training and retraining) based on inputs without being actively programmed by a user to approximate unknown functions, automatically and without user intervention. A machine-learning model can be a multi-modal model utilizing networks and algorithms to learn from, and make predictions on, known data by analyzing training data to learn and relearn to generate outputs that reflect patterns and attributes of the training data. For example, the learning model 302 can employ one or more machine-learning models such as neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc. for performing the techniques described herein.

The learning model 302 can implement one or more large language models (LLMs) capable of generating natural language output by employing the networks and algorithms, such as one or more of the example networks and algorithms described above. The one or more machine-learning models execute on one or more processors, such as one or more processors described further below with reference to FIG. 12. Although various learning models of the modules are described herein, in some implementations two or more of the learning models can be implemented as a single learning model.

The one or more machine-learning models include at least one image recognition machine-learning model (e.g., a vision language model) operable to identify the objects and other features within the input digital image 114 and determine attributes of the objects and other features. The image recognition machine-learning model can be trained on images included by the item catalog data 110 to recognize attributes associated with a variety of different types of objects.

The feature detection module 202 processes the input digital image 114 and outputs environment feature data 304. The environment feature data 304 describes features identified by the feature detection module 202 within the input digital image 114. The identified features may include objects within the environment depicted by the input digital image 114. The objects can be furnishings, for example, such as wall coverings, floor coverings, lighting fixtures, windows, door frames, curtains, and so forth.

The environment feature data 304 describes attributes of the identified features such as a color, shape, style, location, manufacturer, wear, and so forth of the identified features. In some implementations, the feature detection module 202 identifies the features within an entirety of the input digital image 114. However, the feature detection module 202 can also be employed to identify features within a portion of the input digital image 114, with the portion specified according to user input. For example, a user can provide input by selecting a portion of the input digital image 114 within a graphical user interface via a mouse, keyboard, or other user input device to cause the feature detection module 202 to identify features at the selected portion.

To determine some attributes of features depicted by the input digital image 114, such as a size of the features, the feature detection module 202 can compare the identified features to each other. For example, the feature detection module 202 can identify an object in the input digital image 114 that is also described in the item catalog data 110. The item catalog data 110 can specify a size of the identified object, such as a length, width, and height of the object in millimeters. The feature detection module 202 can compare the object to other objects depicted in the input digital image 114 using the specified size to determine a respective size for each object in the input digital image 114.

The feature detection module 202 is further operable to identify attributes of the item depicted in the images included by the item data 128 using the learning model 302. In some instances, the same machine-learning model employed to identify the attributes of the objects in the input digital image 114 is used to identify the attributes of the item described by the item data 128. The attributes can include color, shape, style, location, manufacturer, wear, and so forth of the item. To determine some attributes of the item, such as a size of the item, the feature detection module 202 can utilize existing information included by the item data describing the attributes. For example, the item data can specify the length, width, and/or height of the item in millimeters.

The learning model 302 can be trained to compensate for different perspectives of the images provided to the feature detection module 202 to more accurately determine the attributes described above. For example, the learning model 302 can be trained using the images and size information included in the item catalog data 110 to determine the sizes of objects depicted from various different perspectives, the sizes of objects photographed using lenses having different focal lengths, and so forth.

The feature detection module 202 processes the item data 128 using the learning model 302 and outputs item feature data 306 describing the attributes of the item. The item replacement module 204 receives and processes the environment feature data 304 and the item feature data 306. In some instances, the item replacement module 204 includes a learning model 308 employed to process the data. The learning model 308 includes one or more machine-learning models and is operable to compare the environment feature data 304 and the item feature data 306. The comparing includes, for example, determining similarity between attributes described by the environment feature data 304 and attributes described by the item feature data 306. For example, objects in the input digital image 114 that have attributes similar to the attributes of the item can be identified by the learning model 308 of the item replacement module 204. In some instances, the item replacement module 204 can employ a similarity function or other algorithm to perform the comparison. The similar attributes can include attributes such as size, position, orientation, and so forth.

The item replacement module 204 determines an object within the environment of the input digital image 114 to be virtually replaced (block 1006) as well as the attributes associated with that object (block 1008). As described above, the environment feature data 304 describes the attributes of objects within the input digital image 114. In some instances, the item replacement module 204 can determine the object to be virtually replaced based on the similarities between the attributes of the object and the attributes of the item described by the item data 128. Virtual replacement refers to digital replacement of the depiction of the object in the environment with the depiction of the item described by the item data 128. The virtual replacement of the object can include adjustment of the perspective, size, orientation, lighting, and location of the depiction of the item to convincingly replace the depiction of the object in the environment in a photorealistic manner.

In some instances, the item replacement module 204 can determine the object to be virtually replaced based on user input. For example, the environment feature data 304 can describe particular objects within the input digital image 114. A list of the objects and/or visual indicators for the objects can be displayed via a graphical user interface implemented by the item recommendation and visualization service 122. The visual indicators can include, for example, overlay elements encircling individual objects in the input digital image 114, symbols marking the objects, and so forth. The graphical user interface can be displayed by the user device 104 similar to the examples described further below. The object to be virtually replaced can determined by way of the user input to select the object from the list of the objects and/or the visual indicators. The selection of the object can be included in the environment feature data 304 provided to the item replacement module 204.

The item replacement module 204 further determines the item to virtually replace the object within the environment (block 1010). In the depicted example, the item is associated with the item data 128 and attributes of the item are described by the item feature data 306. As described above, the item data 128 may be associated with an item currently browsed by the user device 104.

In some instances, the item may be selected from a plurality of items having attributes relating to the attributes of the object (block 1012). For example, consider a scenario in which the input digital image 114 is provided to the feature detection module 202 while the user device 104 is not browsing an item. The feature detection module 202 generates the environment feature data 304 by processing the input digital image 114. The feature detection module 202 can further process respective item data for a plurality of items and generate respective instances of item feature data. The item replacement module 204 can select the item to virtually replace the object by determining which item from the plurality of items has attributes that are similar to those described by the environment feature data 304.

The determination of which object in the input digital image 114 is to be virtually replaced with the item described by the item data 128 may be based on a difference between the respective attributes of the object and the item being less than a threshold difference. In some implementations, the item replacement module 204 employs the learning model 308 to determine a respective category associated with each object in the input digital image 114 and a category associated with the item described by the item data 128. Determining the categories can be based on image recognition techniques employed by one or more machine-learning models of the learning model 308, for example. Objects in the input digital image 114 that belong to a same category as the item described by the item data 128 can be identified by the item replacement module 204 as candidate objects for virtual replacement. As one non-limiting example, the category of the item can specify that the item is furniture, that the item belongs to a sub-category of furniture including tables, and that the item belongs to a sub-category of tables including end tables. The object to be virtually replaced can be determined from the candidate objects based on similarity of the attributes of the object to the attributes of the item.

It should be appreciated that in some instances, the object in the input digital image 114 to be virtually replaced can be based on similarity of the object with the item described by the item data 128. Alternatively, the item to virtually replace the object in the input digital image 114 can be based on similarity of the item with the object.

The item replacement module 204 outputs item linking data 310 describing the determined similarities. The item linking data 310 specifies which object in the input digital image 114 is to be virtually replaced by the item described by the item data 128. In some instances, the item linking data 310 describes pairs of matched attributes, where the pairs can include an attribute of the object to be virtually replaced and a corresponding attribute of the item described by the item data 128. For example, a length of the object to be virtually replaced can be paired with a length of the object described by the item data 128.

The image generation module 206 receives the item linking data 310, the input digital image 114, and the item data 128. The image generation module 206 generates the synthesized image 130 with the object replaced by the item within the environment (block 1014). To do so, the image generation module 206 employs a learning model 312. The learning model 312 includes one or more machine-learning models trained to generate synthesized images using item data and input digital images. Specifically, the learning model 312 identifies the object in the input digital image 114 to be replaced by referencing the item linking data 310. The learning model 312 further identifies the item to virtually replace the object by referencing the item linking data 310. The synthesized image 130 generated by the image generation module 206 includes a mixture of visual content from the input digital image 114 and visual content from the one or more images included by the item data 128. The visual content of the input digital image 114 includes the environment depicted by the input digital image 114, and the visual content of the one or more images included by the item data 128 depicts the item.

The synthesized image 130 is provided to the presentation module 212. The presentation module 212 displays the synthesized image via a graphical user interface (block 1016). For example, the presentation module 212 can cause display of the synthesized image 130 in the graphical user interface displayed by the user device 104. The synthesized image 130 is thus employed for visualization of the item described by the item data 128 in the environment depicted by the input digital image 114.

Referring to FIG. 4, an example 400 is shown depicting modules of the item recommendation and visualization service 122. The feature detection module 202 receives the input digital image 114 as described above with reference to FIG. 3. In this example, the feature detection module 202 generates textual descriptions of the objects in the environment of the input digital image 114 (block 1106). In particular, the feature detection module 202 processes the input digital image 114 and employs the learning model 302 to generate an environment textual description 402.

The environment textual description 402 is textual data describing the environment depicted by the input digital image 114 in words. For example, the environment textual description 402 can describe the attributes of the objects and other features within the environment in plain language sentences. In some implementations, the environment textual description 402 can be included in the environment feature data 304. The environment textual description 402 can be generated based on the entire environment or a portion of the environment. For instance, a portion of the environment can be selected via user input, and the environment textual description 402 can be generated to include textual data describing the selected portion. The user input can include, for example, using an input device such as a mouse or trackpad to draw a box enclosing the selected portion. The operations described below can be performed using the environment textual description 402 generated from the selected portion or from the entire environment.

The environment textual description 402 is received by the search keyword module 208. The search keyword module 208 generates search keywords for items having attributes related to the objects (block 1108). In particular, the search keyword module 208 processes the environment textual description 402 to generate search keywords 404 based on the environment textual description 402. The search keywords 404 can be particular words identified by the search keyword module 208 from the environment textual description 402. For instance, the keywords can describe attributes extracted from the environment textual description 402 such as color, size, style, and so forth. In the depicted example, the search keyword module 208 includes a learning model 406. The learning model 406 includes one or more machine learning models trained to identify the search keywords 404 from the environment textual description 402. For example, the learning model 406 can include one or more large language models trained on historical search data of the service provider system 102 to identify the search keywords. By training the learning model 406 on the historical search data, the search keyword module 208 is able to determine search keywords 404 that are more relevant to the particular items described by the item catalog data 110. As a result, a relevance of search results associated with the search keywords 404 can be increased.

The search keywords 404 are received by the search module 210. The search module 210 additionally receives item catalog data 110. The item data 128 is depicted as one instance of item data included by the item catalog data 110. The item catalog data 110 can include item data associated with multiple items as described above.

The search module 210 generates a recommendation that specifies one or more items for inclusion in the environment by comparing the search keywords with data describing the one or more items (block 1110). To do so, the search module 210 performs a search of items described by the item catalog data 110 using the search keywords 404. The search results 408 identify items from the item catalog data 110 that have attributes similar to those described by the search keywords 404. The recommendation can include all of the items identified by the search results 408 or a subset of highly relevant items identified by the search results 408. The recommendation can include hyperlinks to webpages associated with the identified items in some instances.

The search results 408 are received by the presentation module 212. The search results 408 are used by the presentation module 212 to display the recommendation via a graphical user interface (block 1112). For example, the presentation module 212 can display the recommendation including the search results 408 at the user device 104.

The search results 408 can be represented by way of the recommendation in various ways. As one example, the items identified from the item catalog data 110 can be displayed as thumbnail images within the graphical user interface. Users can interact with the thumbnail images to navigate to respective webpages describing the items implemented by the service provider system 102. Selection of one of the items from the recommendation can cause the item data associated with the selected item to be used for generation of a synthesized image. The synthesized image depicts the selected item in an environment of the input digital image 114, as described above with reference to FIG. 3.

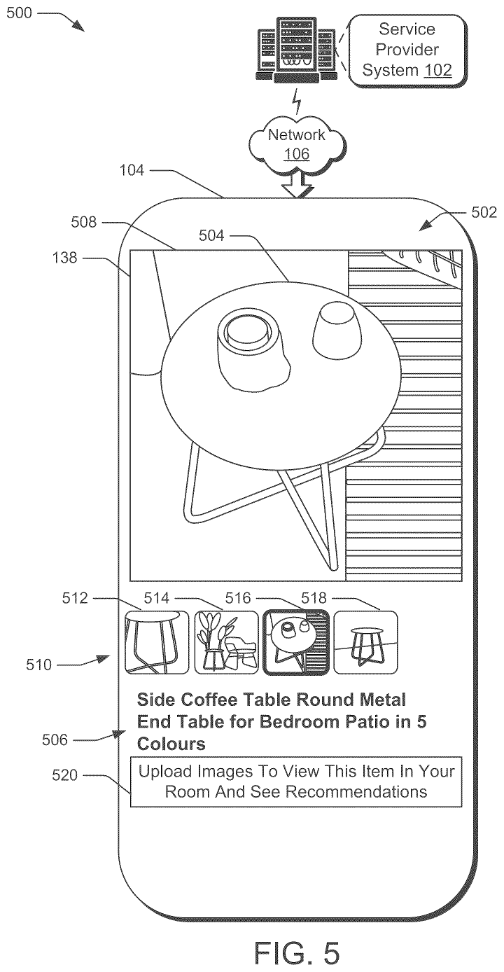

FIGS. 5-9 depict the user device 104 throughout various operations performed in accordance with the described techniques. These figures depict the user device 104 as a smartphone. However, as described above, the user device 104 can be another type of device (e.g., a personal computer, a tablet, etc.) and is not limited to the depicted smartphone.

Referring to FIG. 5, the user device 104 is depicted in an example 500 displaying a graphical user interface 502. The service provider system 102 communicates with the user device 104 over the network 106 as described above to cause the user device 104 to display the graphical user interface 502 and/or various other information. In some implementations, the graphical user interface 502 can be displayed using an application of the user device 104. The application can communicate with the service provider system 102 to retrieve and display information such as item recommendations, generated images, and/or other content in accordance with the described techniques.

The graphical user interface 502 is employed to display information associated with an item 504 described by item data 128 on the service provider system 102. In some instances, the information is included in a webpage associated with the item 504 on the service provider system 102, and the graphical user interface 502 is employed to display the webpage at the user device 104. The information describing the item 504 includes, for example, one or more images of the item 504, a name 506 of the item 504, a description of the item 504, a manufacturer of the item 504, a wear or condition of the item 504, and so forth.

In the depicted example, the item 504 is an end table. However, the item 504 depicted is one non-limiting example item, and the described techniques can be implemented with other types of items described by the item catalog data 110 on the service provider system 102. For example, in other instances the item may be a different type of furniture item such as a couch, desk, shelf, chair, and so forth. In some instances the item may be from a different category of items such as toys, electronics, apparel, appliances, floor coverings, wall coverings, ornaments, exercise equipment, lighting fixtures, window coverings, and so forth.

In the example, the user device 104 displays an enlarged view of item image 138 at the image field of the graphical user interface 502. The item image 138 is one of multiple images of the item 504 included by the item data 128 in this example. The user device 104 additionally displays a group of thumbnail images 510. Each thumbnail image represents a respective enlarged image that can be displayed at an image field 508. Responsive to selection of a thumbnail image by way of user input, the respective enlarged image associated with the selected thumbnail image is displayed at the image field 508.

In the depicted example, the group of thumbnail images 510 includes a first thumbnail image 512, a second thumbnail image 514, a third thumbnail image 516, and a fourth thumbnail image 518. However, in some instances, the item data 128 can include a single enlarged image represented by a single thumbnail image. In other instances, the item data 128 can include a different number of thumbnail images such as two thumbnail images, five thumbnail images, and so forth.

The graphical user interface 502 supports functionality that enables a user to provide one or more images to the service provider system 102 for processing, such as the input digital image 114. In the depicted example, the graphical user interface 502 includes a button 520 that the user can select to cause the graphical user interface 502 to display an image selection menu. The user can select the button 520 by way of input applied via a mouse, keyboard, touchscreen, or other user interface device of the user device 104.

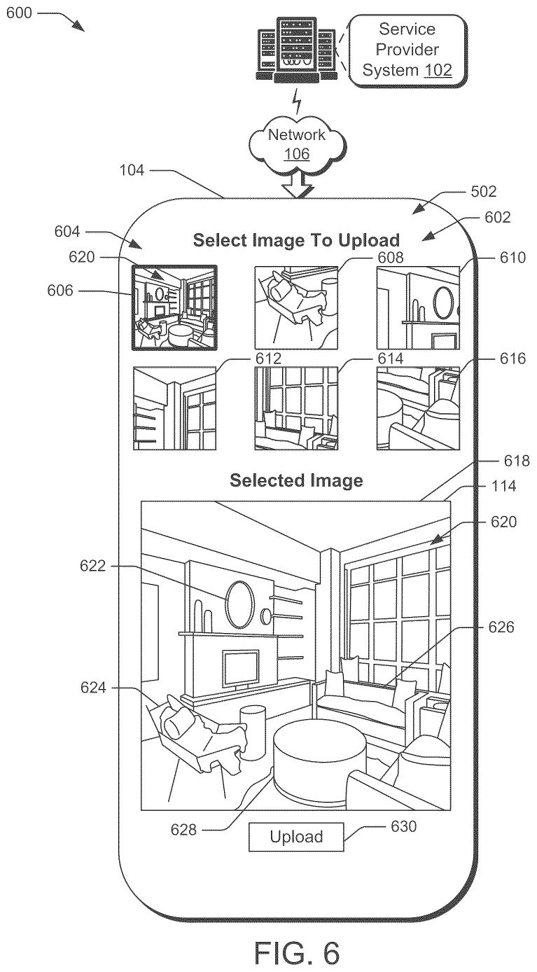

Referring to FIG. 6, the user device 104 is depicted in an example 600 displaying an image selection menu 602. The image selection menu 602 can be displayed responsive to selection of the button 520 as described above.

The image selection menu 602 depicts various images that can be provided to the service provider system 102 for processing. In some instances, the images can be stored locally in a memory or other storage of the user device 104. In some instances, the images can be stored at a location remote from the user device 104, such as in cloud-based storage, and are accessible to the user device 104 over the network 106.

The image selection menu 602 includes thumbnail images 604 representing images that can be selected by the user. In the depicted example, the thumbnail images 604 include a selected thumbnail image 606, a second thumbnail image 608, a third thumbnail image 610, a fourth thumbnail image 612, a fifth thumbnail image 614, and a sixth thumbnail image 616. The respective input digital image 114 represented by the selected thumbnail image 606 is displayed in an image field 618 of the image selection menu 602. In the example shown, the input digital image 114 depicts an environment 620 including various objects. In particular, the environment 620 includes objects such as a mirror 622, a chair 624, a couch 626, and an end table 628.

In the example shown, the selected thumbnail image 606 is indicated with a thicker line border relative to the other thumbnail images. The selected thumbnail image 606 depicts an environment 620 within an interior of a building. The depicted environment 620 includes various objects such as a chair, a couch, a mirror, an end table, and so forth.

Once the desired thumbnail image has been selected, the user can confirm the image associated with the selected thumbnail image 606 by selecting an upload button 630 of the image selection menu 602. Responsive to selecting the upload button 630, the input digital image 114 is provided to the service provider system 102 for processing. In some instances, the user can select multiple thumbnail images, and images associated with the thumbnail images can be provided to the service provider system 102 in a batch or image group.

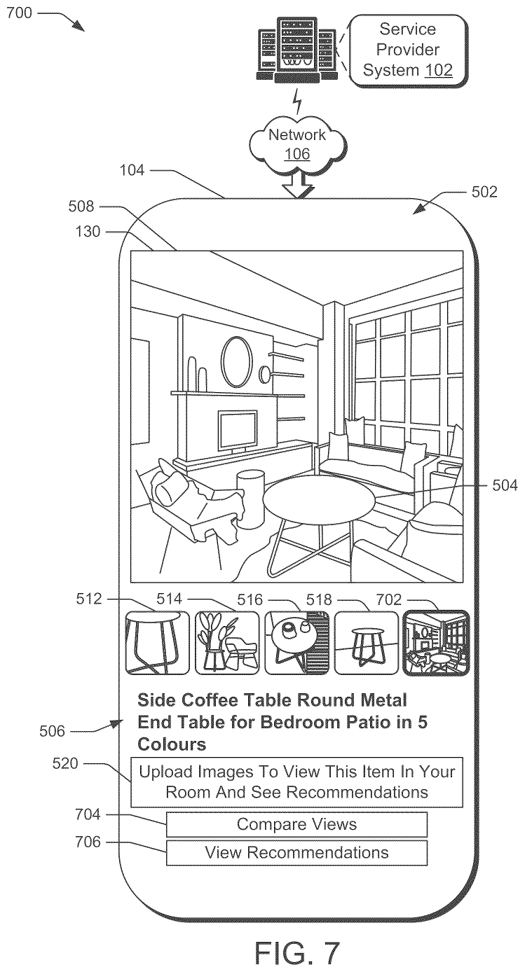

Referring to FIG. 7, the user device 104 is depicted in an example 700 displaying the synthesized image 130 generated using the input digital image 114 associated with the selected thumbnail image 606. In this example, the synthesized image 130 is displayed at the image field 508. Additionally, the service provider system 102 generates a thumbnail image 702 associated with the synthesized image 130. The thumbnail image 702 associated with the synthesized image 130 can be displayed alongside the other thumbnail images and can be selected in a similar manner as described above to adjust which image is displayed at the image field 508.

The synthesized image 130 depicts the environment depicted by the input digital image 114. However, the synthesized image 130 is generated such that the item 504 described by the item data 128 is used to replace a corresponding object in the input digital image 114. In the depicted examples, the item 504 described by the item data 128 is an end table, as shown by FIG. 5 and described above. The item replacement module 204 receives the item feature data 306 identifying the item 504 as the end table. The item replacement module 204 additionally receives the environment feature data 304 as described above. The item replacement module 204 generates item linking data 310 describing the end table 628 of the input digital image 114 as a candidate object for replacement by the end table of the item data 128. Based on this information, the item replacement module 204 outputs the item linking data 310 to the image generation module 206 indicating that the end table 628 in the input digital image 114 is to be replaced with the end table described by the item data 128. The image generation module 206 accordingly generates the synthesized image 130 depicting the end table of the item data 128 within the environment of the input digital image 114. Further, the end table originally depicted by the input digital image 114 is not included in the synthesized image 130, with the end table of the item data 128 instead shown at the location within the environment originally occupied by the end table of the input digital image 114.

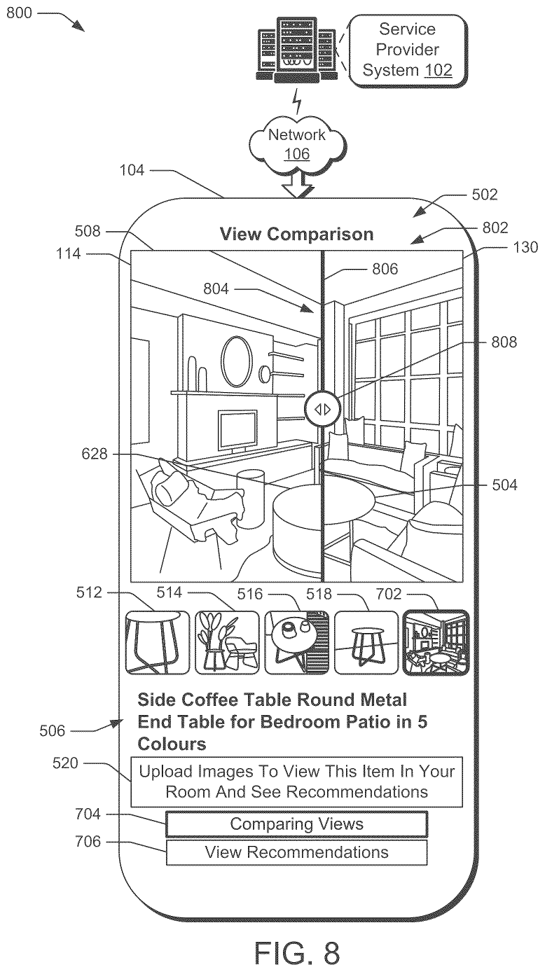

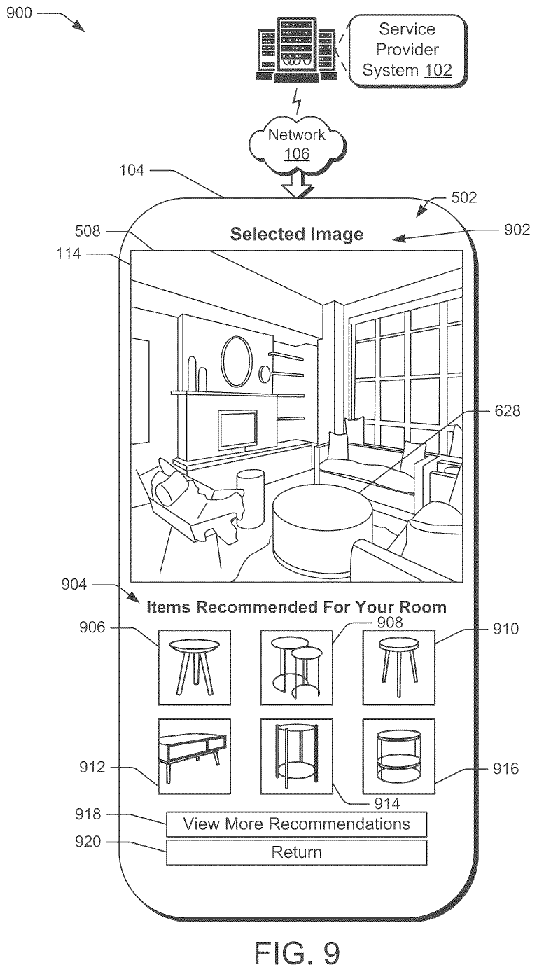

In some implementations, the service provider system 102 supports side-by-side display of portions of the input digital image 114 and the synthesized image 130 for comparison. In the example shown, the graphical user interface 502 includes a button 704 that causes the image field 508 to display the input digital image 114 and the synthesized image 130 concurrently. An example is described below with reference to FIG. 8. The service provider system 102 further supports generation of a recommendation for items based on a content of the input digital image 114, as described further below with reference to FIG. 9. The recommendation can be accessed by way of a button 706, for example.

With respect to FIG. 8, an example 800 depicts the user device 104 displaying a side-by-side comparison 802 of the input digital image 114 and the synthesized image 130. In this example, the graphical user interface 502 displays the input digital image 114 adjacent to the synthesized image 130. An overlay element 804 is arranged between the displayed portion of the input digital image 114 and the displayed portion of the synthesized image 130. In particular, the overlay element 804 includes a vertical line 806 and a circular element 808 centered to the vertical line 806. The displayed portion of the input digital image 114 is at the left side of the vertical line 806, and the displayed portion of the synthesized image 130 is at the right side of the vertical line 806. The overlay element 804 is moveable to adjust the display of the input digital image 114 and the synthesized image 130. A user can drag the circular element 808 and the vertical line 806 together in the left direction or the right direction. When the overlay element 804 is dragged in the left direction, more of the synthesized image 130 is revealed and less of the input digital image 114 is revealed. When the overlay element 804 is dragged in the right direction, more of the input digital image 114 is revealed and less of the synthesized image 130 is revealed.

Thus, the synthesized image 130 can be directly compared with the input digital image 114. This enables the user to more easily visualize the environment depicted by the input digital image 114 with and without the item 504 described by the item data 128.

Referring to FIG. 9, an example 900 depicts the user device 104 displaying a menu 902 including a recommendation 904 for items generated based on the input digital image 114. The menu 902 can be displayed responsive to user selection of the button 706 shown in FIGS. 7-8. In some instances, the recommendation 904 can be displayed responsive to other input. For example, the recommendation 904 can be displayed responsive to the input digital image 114 being received by the service provider system 102.

The service provider system 102 generates the recommendation 904 based on the input digital image 114 using the feature detection module 202, search keyword module 208, and search module 210 as described above with reference to FIG. 4. In doing so, the service provider system 102 identifies various attributes associated with objects within the environment depicted by the input digital image 114. Search keywords 404 are identified that describe the attributes of the objects. The search keywords 404 are used to search the item catalog data 110 for items that have attributes similar to those associated with the objects in the environment. The search results 408 are presented by the presentation module 212 in the form of the recommendation 904 for the identified items.

In the depicted example, the recommendation 904 includes thumbnail images depicting the identified items. In particular, the recommendation 904 is shown including a first thumbnail image 906, a second thumbnail image 908, a third thumbnail image 910, a fourth thumbnail image 912, a fifth thumbnail image 914, and a sixth thumbnail image 916. In other instances, the recommendation 904 can include a different number of thumbnail images. The thumbnail images can link to webpages or other sections of the platform implemented by the service provider system 102 used to display information relating to the items depicted by the thumbnail images.

In some instances, selecting one of the thumbnail images included by the recommendation 904 causes the item recommendation and visualization service 122 to generate and display a corresponding synthesized image. The synthesized image depicts the item associated with the selected thumbnail image in the environment 620. For example, the synthesized image can depict the environment 620 with an object from the input digital image 114 replaced with the item associated with the selected thumbnail image.

In some instances, one or more of the thumbnail images included by the recommendation 904 can be synthesized images depicting respective items of the identified items in the environment 620. For example, once the items have been identified as described above, the item recommendation and visualization service 122 can automatically generate synthesized images depicting the items replacing corresponding objects in the environment 620. The synthesized images can be represented by the thumbnail images in the recommendation 904.

In some instances, the graphical user interface 502 displays a subset of the identified items. Additional identified items can be displayed responsive to user selection of a first button 918. The graphical user interface 502 can transition from displaying the recommendation 904 to displaying the side-by-side comparison 802 responsive to user selection of a second button 920.

By utilizing the described techniques, various functionality of the service provider system 102 can be achieved. For example, the item recommendation and visualization service 122 can be employed to modify the perspective of item images automatically and without human intervention to generate synthesized images depicting the items in environments shown by input digital images.

For example, the learning model 302 of the feature detection module 202 can be trained on image data depicting various items from various different perspectives, such as the item catalog data 110. As described above, the item catalog data 110 can include instances of item data, such as item data 128, associated with different items. Such item data can include one or more images of items, and the learning model 302 can be trained using the item catalog data 110 to detect attributes of features (e.g., objects) depicted in images. Such features can include attributes relating to perspectives of depicted objects such as a size, orientation, position, and foreshortening of the depicted objects. Such features can also include attributes such as lens focal lengths associated with the depictions of the objects. For example, the learning model 302 can be trained to detect attributes of an object in an image such as a distance of the object from a plane of view of the image, a vertical position of the object relative to the plane of view, a lens focal length used to image the object, and so forth.

The learning model 312 of the image generation module 206 can also be trained on image data depicting various items from various different perspectives. The trained learning model 312 can be employed by the image generation module 206 to adjust the perspective of items in the synthesized images. For example, the learning model 312 is operable to adjust the perspective of the item described by the item data 128 to convincingly fit within the environment depicted by the input digital image 114. To do so, the feature detection module 202 can detect perspective attributes of the item described by the item data 128 and perspective attributes of the environment depicted by the input digital image 114. The detected attributes of the environment and the item can be included in the environment feature data 304 and the item feature data 306, respectively. The item linking data 310 output by the environment feature data 304 can describe relationships (e.g., connections, similarities, differences, etc.) between the perspective attributes of the environment and the perspective attributes of the item.

The image generation module 206 receives the item linking data 310 and uses the described relationships to adjust the perspective of the item to fit the perspective of the environment. Adjusting the perspective can include, for example, adjusting the orientation of the item in the synthesized image 130 relative to orientations of the item as depicted in the item data 128, adjusting a foreshortening of the item in the synthesized image 130 relative to foreshortening of the item as depicted in the item data 128, adjusting a position of the item in the synthesized image 130 relative to positions of the item as depicted in the item data 128, adjusting a focal length associated with depiction of the item in the synthesized image 130 relative to focal lengths associated with depictions of the item in the item data 128, and so forth. Adjusting the perspective of the item as described above can occur during generation of the synthesized image 130.

This can enable the system to depict items in the environments using a reduced number of item images relative to approaches that require matching of the depicted perspectives of the items and the depicted perspectives of the environments. The described techniques thus support generation of synthesized images that may difficult or impossible to generate using other techniques such as manual image compositing. The generation of the synthesized images using the described techniques can also be performed in a reduced amount of time relative to other approaches. For example, the system can support generation of synthesized images for multiple different environments concurrently. This can free computational resources of the system for other tasks more quickly, thereby increasing system performance.

Additionally, the system is operable to generate synthesized images on demand responsive to user input. By generating synthesized images on demand, consumption of storage resources of the system such as memory can be reduced relative to approaches that store large quantities of images of items shown in different environments. For example, synthesized images generated using the described techniques can be maintained in storage temporarily until a user navigates away from browsing an item or performs other actions. The synthesized images can then be removed from storage, resulting in reduced consumption of storage resources and increased system performance.

### Example System and Device

Referring to FIG. 12, an example system 1200 is depicted that includes an example computing device that is representative of one or more computing systems and/or devices that are usable to implement the various techniques described herein. This is illustrated through inclusion of the service provider system 102 including the item recommendation and visualization service 122. A computing device 1202 includes, for example, a server of service provider system 102, a device associated with a client (e.g., a client device), an on-chip system, and/or any other suitable computing device or computing system.

The example computing device 1202 as illustrated includes a processing system 1204, one or more computer-readable media 1206, and one or more input/output interfaces 1208 (I/O interfaces) that are communicatively coupled, one to another. Although not shown, the computing device 1202 further includes a system bus or other data and command transfer system that couples the various components, one to another. For example, a system bus includes any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 1204 is representative of functionality to perform one or more operations using hardware. Accordingly, the processing system 1204 is illustrated as including hardware elements 1210 that are configured as processors, functional blocks, and so forth. This includes example implementations in hardware as a system specific integrated circuit or other logic device formed using one or more semiconductors. The hardware elements 1210 are not limited by the materials from which they are formed or the processing mechanisms employed therein. For example, processors are comprised of semiconductor(s) and/or transistors (e.g., electronic integrated circuits (ICs)). In such a context, processor-executable instructions are, for example, electronically-executable instructions.

The computer-readable media 1206 is illustrated as including memory/storage 1212. The memory/storage 1212 represents memory/storage capacity associated with one or more computer-readable media. In one example, the memory/storage 1212 includes volatile media (such as random access memory (RAM)) and/or nonvolatile media (such as read only memory (ROM), Flash memory, optical disks, magnetic disks, and so forth). In another example, the memory/storage 1212 includes fixed media (e.g., RAM, ROM, a fixed hard drive, and so on) as well as removable media (e.g., Flash memory, a removable hard drive, an optical disc, and so forth). The computer-readable media 1206 is configurable in a variety of other ways as further described below.

Input/output interface(s) 1208 are representative of functionality to allow user input to enter commands and information to computing device 1202, and also allow information to be presented and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which employs visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are implementable on a variety of commercial computing platforms having a variety of processors.

Implementations of the described modules and techniques are storable on or transmitted across some form of computer-readable media. For example, the computer-readable media includes a variety of media that is accessible to the computing device 1202. By way of example, and not limitation, computer-readable media includes “computer-readable storage media” and “computer-readable signal media.”

“Computer-readable storage media” refers to media and/or devices that enable persistent and/or non-transitory storage of information in contrast to mere signal transmission, carrier waves, or signals per se. Thus, computer-readable storage media refers to non-signal bearing media. The one-or-more computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which are accessible to a computer.

“Computer-readable signal media” refers to a signal-bearing medium that is configured to transmit instructions to the hardware of the computing device 1202, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of modules, programmable device logic and/or fixed device logic implemented in a hardware form that is employable in some embodiments to implement at least some aspects of the techniques described herein, such as to perform one or more instructions. Hardware includes components of an integrated circuit or on-chip system, a system-specific integrated circuit (ASIC), a field-programmable gate array (FPGA), a complex programmable logic device (CPLD), and other implementations in silicon or other hardware. In this context, hardware operates as a computing device that performs program tasks defined by instructions and/or logic embodied by the hardware as well as a hardware utilized to store instructions for execution, e.g., the computer-readable storage media described previously.

Combinations of the foregoing are also employable to implement various techniques described herein. Accordingly, software, hardware, or executable modules are implementable as one or more instructions and/or logic embodied on some form of computer-readable storage media and/or by one or more hardware elements 1210. For example, the computing device 1202 is configured to implement particular instructions and/or functions corresponding to the software and/or hardware modules. Accordingly, implementation of a module that is executable by the computing device 1202 as software is achieved at least partially in hardware, e.g., through use of computer-readable storage media and/or hardware elements 1210 of the processing system 1204. The instructions and/or functions are executable/operable by one or more articles of manufacture (for example, one or more computing devices 1202 and/or processing systems 1204) to implement techniques, modules, and examples described herein.

The techniques described herein are supportable by various configurations of the computing device 1202 and are not limited to the specific examples of the techniques described herein. This functionality is also implementable entirely or partially through use of a distributed system, such as over a “cloud” 1014 as described below.

The cloud 1214 includes and/or is representative of a platform 1216 for resources 1218. The platform 1216 abstracts underlying functionality of hardware (e.g., servers) and software resources of the cloud 1214. For example, the resources 1218 include systems and/or data that are utilized while computer processing is executed on servers that are remote from the computing device 1202. In some examples, the resources 1218 also include services provided over the Internet and/or through a subscriber network, such as a cellular or Wi-Fi network.

The platform 1216 abstracts the resources 1218 and functions to connect the computing device 1202 with other computing devices. In some examples, the platform 1216 also serves to abstract scaling of resources to provide a corresponding level of scale to encountered demand for the resources that are implemented via the platform. Accordingly, in an interconnected device embodiment, implementation of functionality described herein is distributable throughout the system 1200. For example, the functionality is implementable in part on the computing device 1202 as well as via the platform 1216 that abstracts the functionality of the cloud 1214.

In some aspects, the techniques described herein relate to a method implemented by a computing device, including: receiving a digital image via user input, the digital image depicting an environment; processing the digital image using at least one machine-learning model to identify an object depicted within the environment and generate a textual description of the object; generating at least one search keyword describing at least one attribute related to the object using the at least one machine-learning model; generating a recommendation specifying one or more items for inclusion in the environment by comparing the at least one search keyword with data describing the one or more items; and displaying the recommendation via a graphical user interface.

In some aspects, the techniques described herein relate to a method, wherein the at least one search keyword is based on the textual description.

In some aspects, the techniques described herein relate to a method, wherein the at least one machine-learning model includes a vision language model trained to identify the object depicted within the environment and generate the textual descriptions of the object, and a large language model trained to generate the at least one search keyword based on the textual descriptions.

In some aspects, the techniques described herein relate to a method, wherein the at least one search keyword specifies the at least one attribute, and the at least one attribute is extracted from the textual description.

In some aspects, the techniques described herein relate to a method, wherein the data describing the one or more items is item catalog data of a service provider system.

In some aspects, the techniques described herein relate to a method, wherein the one or more items are from different categories of items specified by the item catalog data.

In some aspects, the techniques described herein relate to a method, wherein the at least one machine-learning model is trained on historical search data of a service provider system.

In some aspects, the techniques described herein relate to a method, wherein displaying the recommendation via the graphical user interface includes displaying one or more synthesized images depicting the one or more items in the environment.

In some aspects, the techniques described herein relate to a method, wherein selecting one of the one or more synthesized images causes the selected synthesized image to be displayed side-by-side with the digital image depicting the environment.

In some aspects, the techniques described herein relate to a method implemented by a computing device, including: receiving a digital image via user input, the digital image depicting an environment; processing the digital image to identify one or more objects depicted within the environment using at least one machine-learning model; determining an object from the one or more objects to be virtually replaced and at least one attribute associated with the object; determining an item to virtually replace the object within the environment, the item selected from a plurality of items having item attributes relating to the at least one attribute of the object; generating a synthesized image with the object replaced by the item within the environment; and displaying the synthesized image via a graphical user interface.

In some aspects, the techniques described herein relate to a method, wherein the at least one attribute of the object includes a category of the object.

In some aspects, the techniques described herein relate to a method, wherein generating the synthesized image includes adjusting a perspective of the item within the environment in the synthesized image to match a perspective of the object within the environment in the digital image.

In some aspects, the techniques described herein relate to a method, further including displaying the plurality of items with the synthesized image via the graphical user interface, where each item of the plurality of items is selectable via user input to generate another synthesized image with the object replaced by the selected item within the environment.

In some aspects, the techniques described herein relate to a method, further including generating a plurality of synthesized images, each synthesized image of the plurality of synthesized images depicting the environment with the object replaced by a corresponding item of the plurality of items, and displaying the plurality of synthesized images via the graphical user interface.

In some aspects, the techniques described herein relate to a method, wherein generating the synthesized image includes adjusting a size of the item within the environment in the synthesized image based on a size of the item described by the item attributes.

In some aspects, the techniques described herein relate to a method, wherein displaying the synthesized image via the graphical user interface includes displaying the synthesized image adjacent to the digital image depicting the environment.

In some aspects, the techniques described herein relate to a method, wherein displaying the synthesized image adjacent to the digital image depicting the environment includes displaying an overlay element, the overlay element moveable in a first direction to reveal more of the synthesized image and less of the digital image depicting the environment, and the overlay element moveable in a second direction to reveal less of the synthesized image and more of the digital image depicting the environment.

In some aspects, the techniques described herein relate to a system, including: one or more computing devices; and one or more computer-readable storage media storing instructions which, when executed by the one or more computing devices, cause the one or more computing devices to perform operations including: receiving a digital image via user input, the digital image depicting an environment; processing the digital image using at least one machine-learning model to identify one or more objects depicted within the environment and generate at least one textual description of the one or more objects; generating search keywords for items having attributes related to the one or more objects using the at least one machine-learning model; generating a recommendation specifying one or more items for inclusion in the environment by comparing the search keywords with data describing the one or more items; and displaying the recommendation via a graphical user interface.

In some aspects, the techniques described herein relate to a system, the operations further including: determining an object from the one or more objects and attributes associated with the object, the object to be virtually replaced; determining an item from the one or more items to virtually replace the object within the environment; generating a synthesized image with the object replaced by the item within the environment; and displaying the synthesized image via the graphical user interface.

In some aspects, the techniques described herein relate to a system, wherein displaying the recommendation via the graphical user interface includes displaying one or more synthesized images depicting the one or more items in the environment.

### Conclusion

Although the systems and techniques have been described in language specific to structural features and/or methodological acts, it is to be understood that the systems and techniques defined in the appended claims are not necessarily limited to the specific features or acts described. Rather, the specific features and acts are disclosed as example forms of implementing the claimed subject matter. Further, various different examples are described and it is to be appreciated that each described example is implementable independently or in connection with one or more other described examples.

What is claimed is:

1. A method implemented by a computing device, comprising:
receiving a digital image via user input, the digital image depicting an environment;
processing the digital image using at least one machine-learning model to identify an object depicted within the environment and generate a textual description of the object;
generating at least one search keyword describing at least one attribute related to the object using the at least one machine-learning model;
generating a recommendation specifying one or more items for inclusion in the environment by comparing the at least one search keyword with data describing the one or more items; and
displaying the recommendation via a graphical user interface.

2. The method of claim 1, wherein the at least one search keyword is based on the textual description.

3. The method of claim 1, wherein the at least one machine-learning model includes a vision language model trained to identify the object depicted within the environment and generate the textual description of the object, and a large language model trained to generate the at least one search keyword based on the textual description.

4. The method of claim 1, wherein the at least one search keyword specifies the at least one attribute, and the at least one attribute is extracted from the textual description.

5. The method of claim 1, wherein the data describing the one or more items is item catalog data of a service provider system.

6. The method of claim 5, wherein the one or more items are from different categories of items specified by the item catalog data.

7. The method of claim 1, wherein the at least one machine-learning model is trained on historical search data of a service provider system.

8. The method of claim 1, wherein displaying the recommendation via the graphical user interface includes displaying one or more synthesized images depicting the one or more items in the environment.

9. The method of claim 8, wherein selecting one of the one or more synthesized images causes the selected synthesized image to be displayed side-by-side with the digital image depicting the environment.

10. A method implemented by a computing device, comprising:
receiving a digital image via user input, the digital image depicting an environment;
processing the digital image to identify one or more objects depicted within the environment using at least one machine-learning model;
determining an object from the one or more objects to be virtually replaced and at least one attribute associated with the object;
determining an item to virtually replace the object within the environment, the item selected from a plurality of items having item attributes relating to the at least one attribute of the object;
generating a synthesized image with the object replaced by the item within the environment; and
displaying the synthesized image via a graphical user interface.

11. The method of claim 10, wherein the at least one attribute of the object includes a category of the object.

12. The method of claim 10, wherein generating the synthesized image includes adjusting a perspective of the item within the environment in the synthesized image to match a perspective of the object within the environment in the digital image.

13. The method of claim 10, further comprising displaying the plurality of items with the synthesized image via the graphical user interface, where selection of an item of the plurality of items via user input generates another synthesized image with the object replaced by the selected item within the environment.

14. The method of claim 10, further comprising generating a plurality of synthesized images, each synthesized image of the plurality of synthesized images depicting the environment with the object replaced by a corresponding item of the plurality of items, and displaying the plurality of synthesized images via the graphical user interface.

15. The method of claim 10, wherein generating the synthesized image includes adjusting a size of the item within the environment in the synthesized image based on a size of the item described by the item attributes.

16. The method of claim 10, wherein displaying the synthesized image via the graphical user interface includes displaying the synthesized image adjacent to the digital image depicting the environment.

17. The method of claim 10, wherein displaying the synthesized image adjacent to the digital image depicting the environment includes displaying an overlay element, the overlay element moveable in a first direction to reveal more of the synthesized image and less of the digital image depicting the environment, and the overlay element moveable in a second direction to reveal less of the synthesized image and more of the digital image depicting the environment.

18. A system, comprising:
one or more computing devices; and
one or more computer-readable storage media storing instructions which, when executed by the one or more computing devices, cause the one or more computing devices to perform operations comprising:
receiving a digital image via user input, the digital image depicting an environment;
processing the digital image using at least one machine-learning model to identify one or more objects depicted within the environment and generate at least one textual description of the one or more objects;
generating search keywords for items having attributes related to the one or more objects using the at least one machine-learning model;
generating a recommendation specifying one or more items for inclusion in the environment by comparing the search keywords with data describing the one or more items; and
displaying the recommendation via a graphical user interface.

19. The system of claim 18, the operations further comprising:
determining an object from the one or more objects and attributes associated with the object, the object to be virtually replaced;
determining an item from the one or more items to virtually replace the object within the environment;
generating a synthesized image with the object replaced by the item within the environment; and
displaying the synthesized image via the graphical user interface.

20. The system of claim 18, wherein displaying the recommendation via the graphical user interface includes displaying one or more synthesized images depicting the one or more items in the environment.
